(19) United States
(12) Patent Application Publication
(10) Pub. No.: US 2006/0064909 A1
(43) Pub. Date: Mar. 30, 2006

(54) Display assembly and method

(76) Inventor: Paul Belokin, Denton, TX (US)

Correspondence Address: JACK A. KANZ, 502 SOUTH COTTONWOOD DRIVE, RICHARDSON, TX, 75080, US

(21) Appl. No.: 10/949,937

(22) Filed: Sep. 24, 2004

(51) Int. Cl. G09F 19/08

(52) U.S. Cl. 40/414

(57) ABSTRACT

A display assembly has been provided to store and display an item that includes a first member and a second member. An upper end of the first member is positionable with a lower end of the second member in a first position. An upper end of the second member is positionable with a lower end of the first member in a second position. The first and second member in the first position stores the item. The first and second members in the second position display the item. In one configuration, a container is provided that supports the item. Additionally, a method of storing and displaying items has been provided.

### TECHNICAL FIELD OF THE INVENTION

The present invention relates generally to the field of objects utilized for placing items on display and more particularly, but not by way of limitation, to a display assembly and method.

### BACKGROUND OF THE INVENTION

For a variety of different occasions (e.g., Valentine's Day, birthdays, anniversaries, and the like), individuals like to send other individuals a variety of gifts or items, including, but not limited to flowers, candy, cookies or the like. In the transmittal of such items, care is taken to preserve the condition of the items (e.g., to avoid a crushing of the flowers or to avoid a crumbling of the cookies). Preservation techniques include packing or surrounding the items in protective containers. With such protective containers, a concern arises. Once the item arrives at its location, the protective container is typically thrown away, resulting (to a certain degree) in waste. Such a waste concern is further extended when such items are shipped via mail. In such mail shipments, further types of protective containers are utilized—then thrown away and wasted.

Other concerns can additionally arise with the receipt of gifts or items. Some gift items by design are intended to have a certain desired effect: pointing out to everyone in the immediate surrounding area that the recipient has received a gift or item. A traditional approach in either accentuating the fact that a recipient has received an item or accentuating the presence of a particular item is to enlarge the item. As an example, an individual may receive a large cluster of balloons. While such accentuation techniques can have the desired effect, they at times can become cumbersome—thus, the concern.

Separate and apart from receiving gifts, concerns arise with techniques utilized to accentuate a particular item at a party or an event. A variety of traditional techniques include a variation of colors, creative placement of decorations, or the like. However, at times, such traditional techniques do not ultimately have the desired effect.

### SUMMARY OF THE INVENTION

From the foregoing it may be appreciated that a need has arisen for a display assembly and method. In accordance with the present invention, a display assembly and method has been provided that substantially eliminate one or more of the disadvantages and problems outlined above.

According to an aspect of the present invention, a display assembly, operable for storing and displaying an item has been provided. The display assembly comprises a first member and a second member operable for positioning with the first member. An upper end of the first member is positionable with a lower end of the second member in a first position. An upper end of the second member is positionable with a lower end of the first member in a second position. The first member and the second member in the first position store the item. The first member and the second member in the second position display the item.

According to another aspect of the present invention, a method of storing and displaying an item has been provided. The method comprises providing a display assembly with a first member and second member, the second member operable for positioning with the first member; storing the item in a first position of the display assembly by positioning an upper end of the first member with a lower end of the second member; transitioning the display assembly to a second position by positioning an upper end of the second member with a lower end of the first member; and displaying the item with the display assembly in the second position.

According to another aspect of the present invention, an apparatus, operable for displaying and accentuating an item has been provided. The apparatus comprises a container, an object, and a motor assembly. The container comprises a container body, operable for storing the item, wherein the container body defines a container space that extends from a lower end of the body. The motor assembly is positioned with the container and comprises a spinner and a wire. The object is suspended from the wire. The spinner spins the wire and object around the container to accentuate the item within the container body.

The various embodiments and implementations of the present invention provide a profusion of potential technical advantages and benefits. A technical advantage of the present invention may include the capability to utilize a container for not only storing and/or shipping an item, but also displaying the item.

Another technical advantage of the present invention may include the capability to accentuate a display assembly and/or items contained therein.

Yet another technical advantage of the present invention may include the capability to protect an item while accentuating the item with a movable object thereabove.

Still yet another technical advantage of the present invention may include the capability to facilitate a marketing of a display assembly via a stackability of display assemblies and an accentuation of the display assembly with the top display assembly.

Other technical advantages may be readily apparent to one skilled in the art after review of following figures and description, associated herewith.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a front perspective view of a configuration of a display assembly in a packaged position;

FIG. 2 is a top perspective view of another configuration of a display assembly;

FIG. 3 is a perspective view of another configuration of a display assembly;

FIG. 4 is a perspective view of a configuration of a display assembly in a display position;

FIG. 5 is a perspective view of a configuration of a display assembly in a protected display position;

FIG. 6 is a perspective view of a configuration of a display assembly in a partial display position;

FIG. 7 is a top perspective view of a configuration of a container;

FIGS. 8 and 9 are illustrative of a motor assembly that can be utilized, according to several configurations of the invention;

FIG. 10 is a perspective view of a configuration of a display assembly, illustrating details of a first member and a second member;

FIG. 11 is a perspective view of a configuration of the display assembly in a globe assembly position;

FIG. 12 is a perspective view of a positioning of a motor assembly within a container;

FIGS. 13 and 14 show the mounting of a container within a first member; and

FIG. 15 is a perspective view of a configuration of a display assembly in a market display position.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementations illustrated and described herein. Additionally, the drawings contained herein are not necessarily drawn to scale.

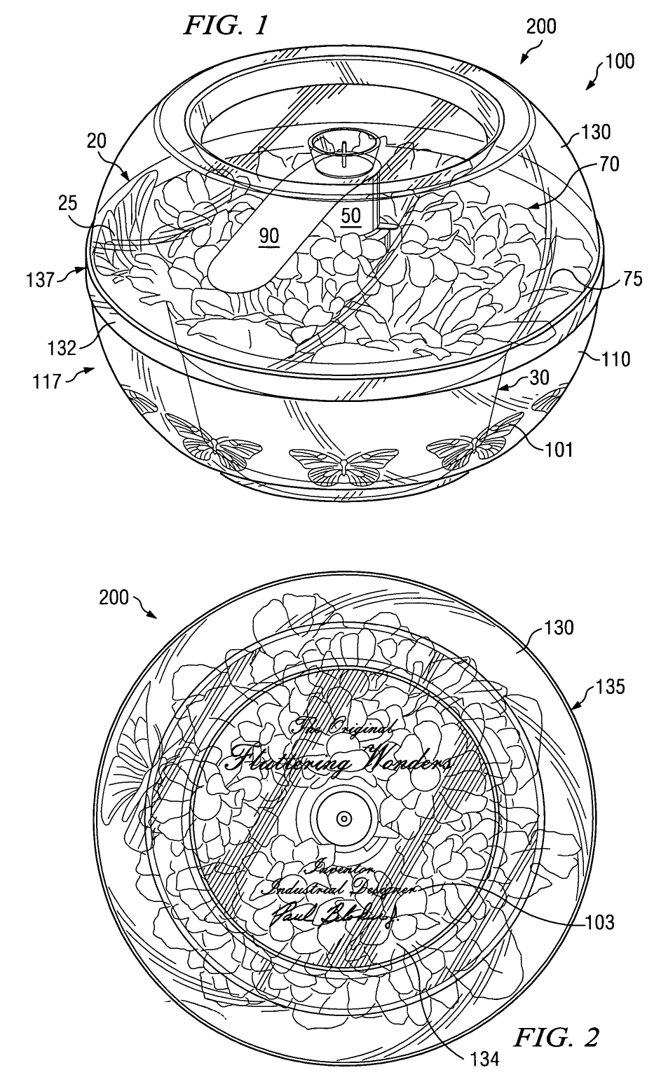

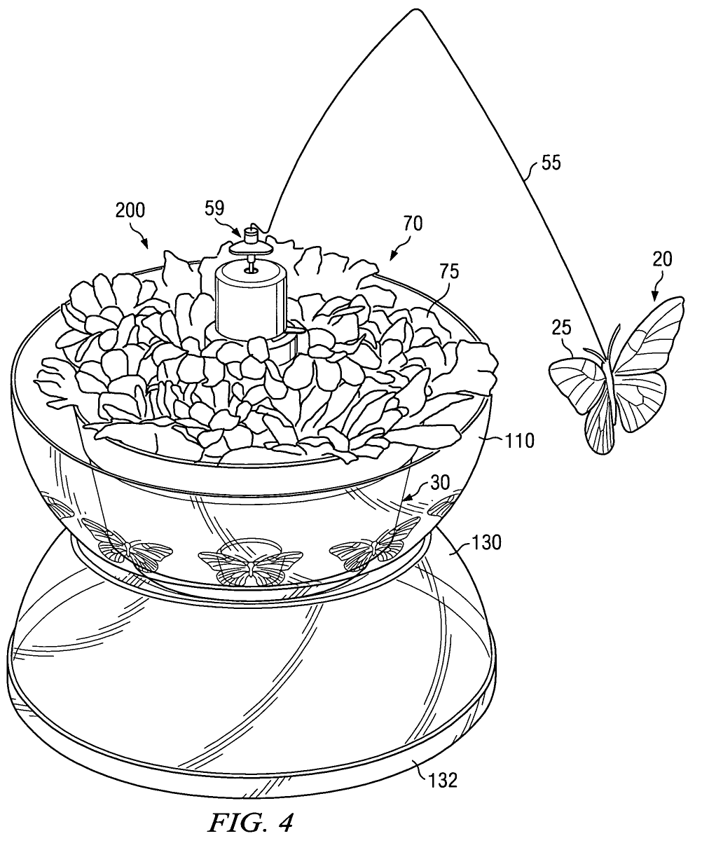

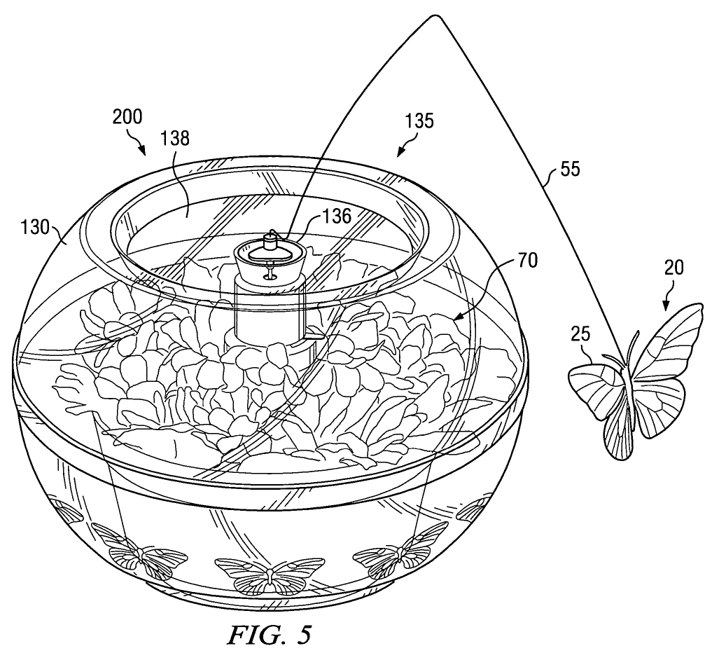

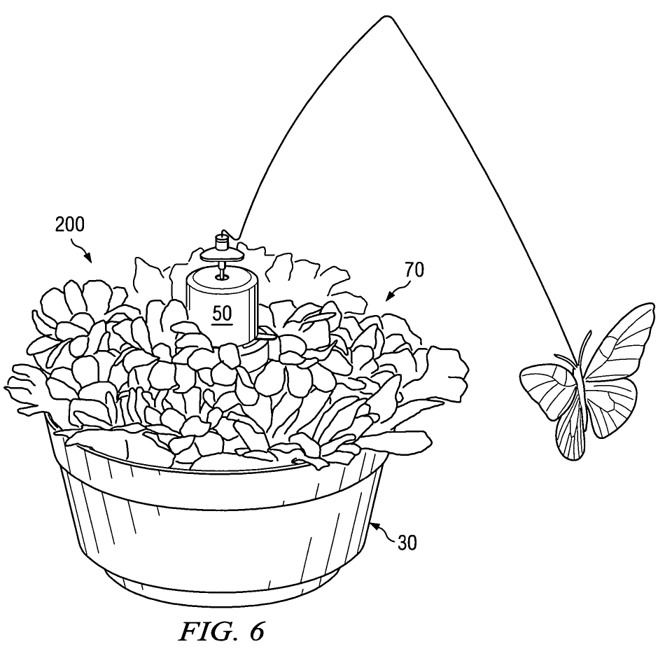

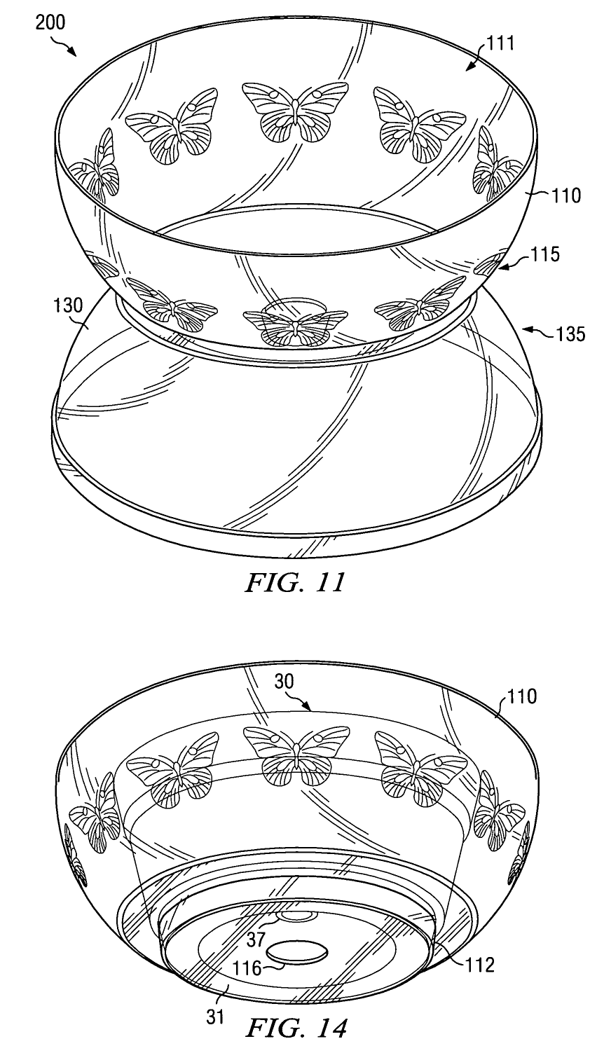

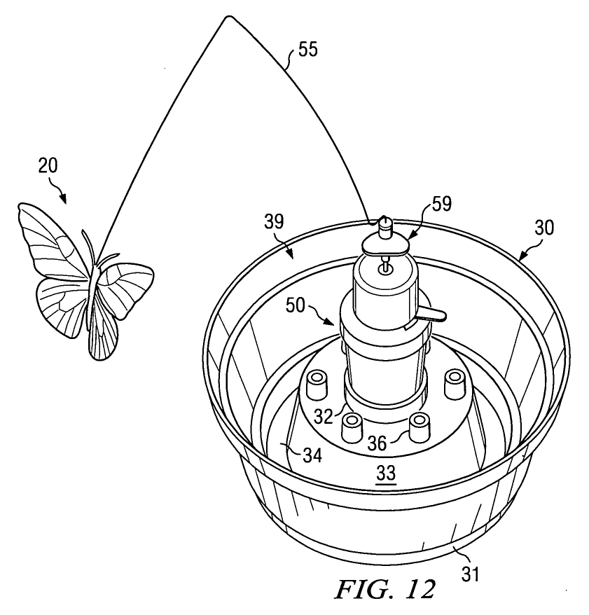

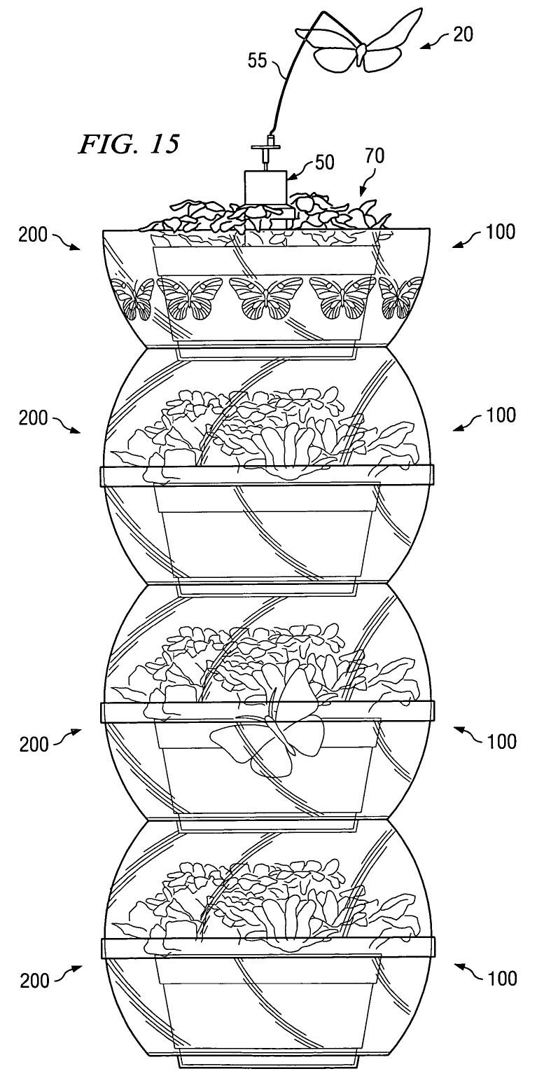

FIGS. 1-15 generally illustrate several configurations and features of a display assembly 200. According to an aspect of the invention, certain features of the display assembly 200 have a flexibility, which allows the display assembly to be utilized in a variety of manners and/or positions. As an example, intended for illustrative purpose only, FIG. 1 generally shows a packaged position configuration, FIG. 4 generally shows a display position configuration, FIG. 5 generally shows a protected display position configuration, FIG. 6 generally shows a partial display position configuration, FIG. 11 generally shows a globe assembly display position configuration, and FIG. 15 generally shows a marketing display position configuration. Details of such “utilization” positions will be expounded upon in further detail below. Other utilization positions will become apparent to one of ordinary skill in the art after review of the specification herein. While specific configurations will be shown and described with respect to these positions, it should be expressly understood that other configurations for each specific position can be utilized as will become apparent to one of ordinary skill in the art after review of the specification herein.

FIG. 1 is a perspective view, generally illustrating a packaged position configuration. In description of this packaged position configuration, several components parts (capable of being utilized in several configurations) will generally be introduced and then described in more detail below. The packaged position configuration is generally a position in which the display assembly 200 can be placed when the display assembly 200 is being stored and/or shipped—that is not being used. Such a configuration would be particularly useful when shipping the display assembly 200 or packaging the display assembly 200 to be sold.

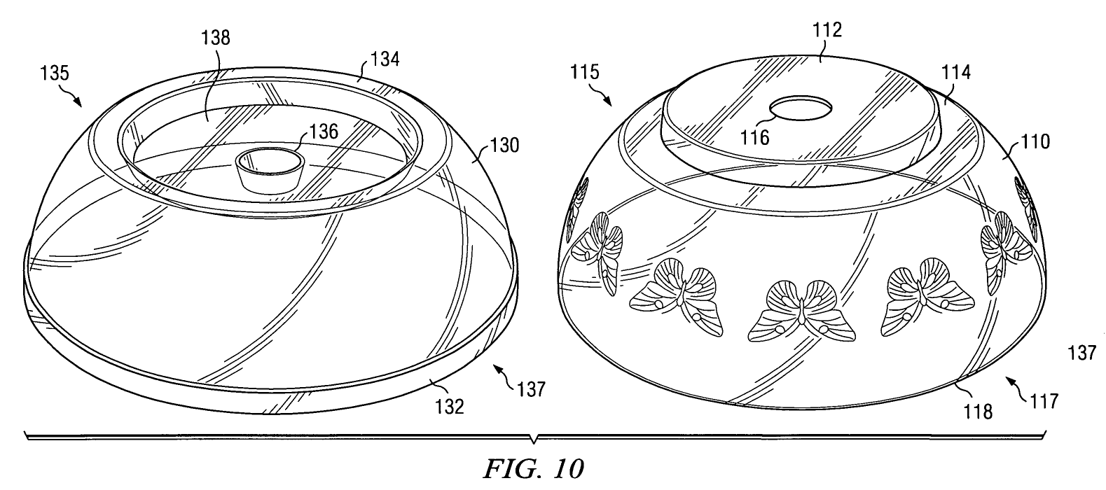

The display assembly 200 in the configuration of FIG. 1 generally includes a globe assembly 100, a container 30, display item(s) 70, an object 20, a label 90, and a motor assembly 50. The globe assembly 100, as will be described in further details below, generally includes a first member 110 and a second member 130 that are positioned to store or house the remaining portions of the display assembly 200 (e.g., the container 30, display item(s) 70, an object 20, a label 90, and a motor assembly 50). The positioning of the second member 130 with the first member 110, for example, includes a lip 132 on a lower end 137 of the second member 130 being positioned over an edge 118 (seen in FIG. 10) on the upper end 117 of the first member 110. While such a configuration is shown, it should be understood that a variety of other configurations could be utilized as will become apparent to one of ordinary skill in the art. As an example, intended for illustrative purpose only, the lip could be positioned on the upper end 117 of the first member 110 instead of the lower end 137 of the second member 130.

The globe assembly 100 can be made of virtually any material, including but not limited to, various grades of plastics, woods, metals, and the like. In a preferred configuration, the globe assembly 100 is made of a clear plastic material that is operable for allowing a clear view of the materials disposed within the globe assembly 100 (e.g., in this configuration the container 30, display item(s) 70, an object 20, and the label 90). The globe assembly 100 can additionally include a variety of container markings 101, which in this configuration is shown as a butterfly.

The remaining items, described in more details below generally include the container 30, the display item(s) 70, the object 20, the label 90, and the motor assembly 50. The container 30 can generally be arranged and designed to support or hold display item(s) 70. In this specific configuration, the display item(s) 70 is floral material 75 and the object 20 is a butterfly 25; however, as will be described in more details, the display item(s) 70 and object 20 can any of a variety of things.

FIG. 2 is a top perspective view of another configuration of a display assembly 200. In this configuration, a designer insignia 103 is placed on a second portion 134 of an upper end 135 of the second member 130.

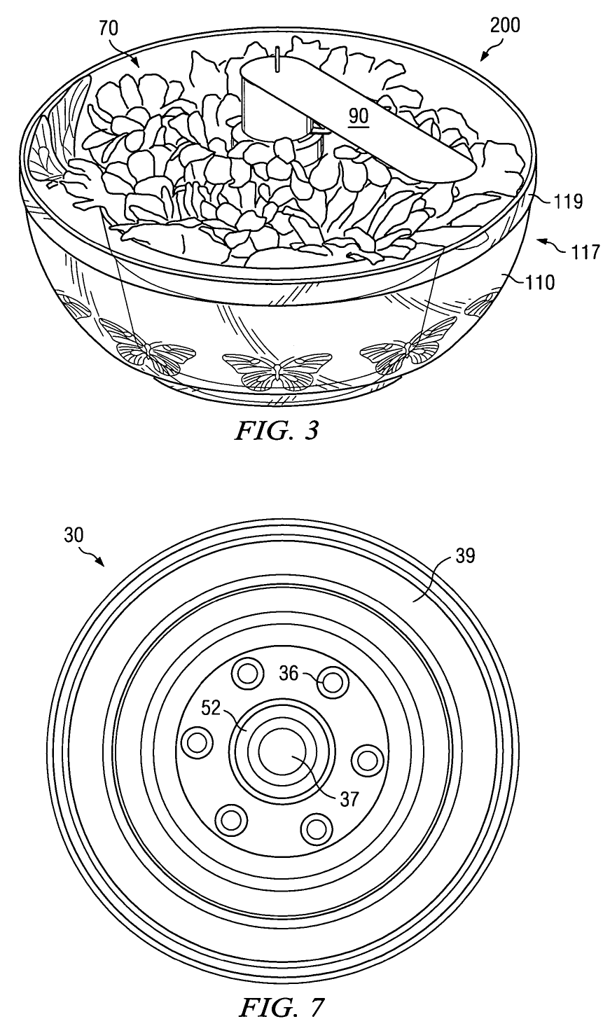

FIG. 3 is a perspective view of another configuration of the display assembly 200 similar to FIG. 1. In this configuration, a second member 130 (not shown) has been removed exposing the display item(s) 70. The label 90 is generally shown, which can include a variety of items, including but not limited to, instructions on how to operate the display assembly 200, the manufacturer, contact information on how to purchase further devices, and the like. In this configuration a lip 119 is shown positioned on the upper end 117 of the first member 110 instead of the lower end 137 of the second member 130 as shown in FIG. 1 (seen in more detail in FIG. 10). Such a configuration is intended as showing that a variety of different configurations can be utilized with the display assembly 200.

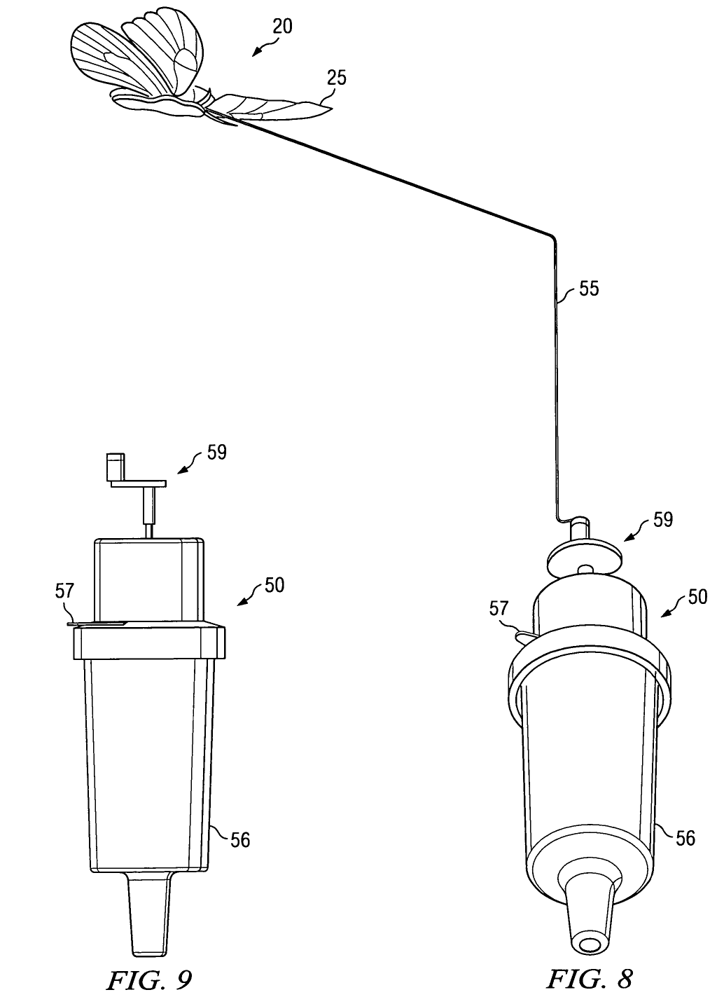

FIG. 4 is a perspective view of a configuration of the display assembly 200 transitioned into a display position. As an example, intended for illustrative purposes only, the first member 110 has been placed upon the second member 130 and a wire 55 has been positioned with the motor assembly 50 to suspend the object 20 over the display assembly 200. Upon activation of the motor assembly 50 (described with reference to FIGS. 8 and 9 below), a spinner 59 begins to move, fluctuating the wire 55 such that the object 20 appears to be floating or flapping around the display assembly 200 and the display item(s) 70. As an example, intended for illustrative purposes only, the object 20 can be a butterfly 25 and the display item(s) 70 can be floral material 75 such that the butterfly 25 appears to be flying around the floral material 75.

With this configuration, it can clearly be seen that the object 20, in addition to providing stunning visual entertainment, also accentuates the display assembly 200 and display item(s) 70 therein. In other words, the display assembly 200 not only draws attention to the display assembly 200, itself, but the display assembly 200 also draws attention to the display item(s) 70 disposed within the container 30 of the display assembly 200.

While the object 20 has been shown as a butterfly 25 and the display item(s) 70 has been shown as floral material 75, it should be expressly understood that the object 20 and the display item(s) 70 can be a virtual limitless number of objects/items. Illustrative examples follow: a witch, a bat or a ghost (the object 20) could be flying around Halloween candy or cookies (the display item(s) 70); a cupid figure (the object 20) could be flying around Valentine treats, conversational hearts, or the like (the display item(s) 70); a dancing jalapeno (the object 20) could be flapping around chips and salsa (the display item(s) 70); a stork (the object 20) could be flying around candy cigars with “congratulations, it's a boy” signs marked thereon (the display item(s) 70); or a “Happy Birthday” sign (the object 20) could be flying around birthday cookies (the display item(s) 70). As can be seen, the types of objects 20 and display item(s) 70 are limitless. After review of the specification, other objects 20 and display item(s) 70 should become apparent to one of ordinary skill in the art.

While the display item(s) 70 has been shown positioned within the container 30 in this configuration, it should be expressly understood that in other configurations, the display item(s) 70 can be positioned in other locations. For example, in some configurations, the display item(s) 70 can be positioned within a container area 111, defined by the first member 110 (as shown in FIG. 11).

FIG. 5 is a perspective view of a display assembly 200 transitioned into a protected display position. In some configurations, it may be desirable to protect the display item(s) 70, yet still accentuate the display assembly 200 and display item(s) 70 by having the object 20 fly therearound. To allow such a feature, the second member 130 in this configuration has been provided with an opening 136 in a second portion 138 on the upper end 135 of the second member 130.

In the preferred configuration, the second member 130 is made of a clear plastic material. Thus, it can be seen that the object 20 can still take on the appearance of flying around the display item(s) 70 (seen through the clear plastic material of the second member 130) while the display item(s) 70 are protected within the second member 130.

FIG. 6 shows a perspective view of a display assembly 200 transitioned into a partial display position. This configuration illustrates that the container 30 can be removed from the globe assembly 100 in some configurations and used by itself to accentuate whatever is in the container 30—e.g., the display item(s) 70.

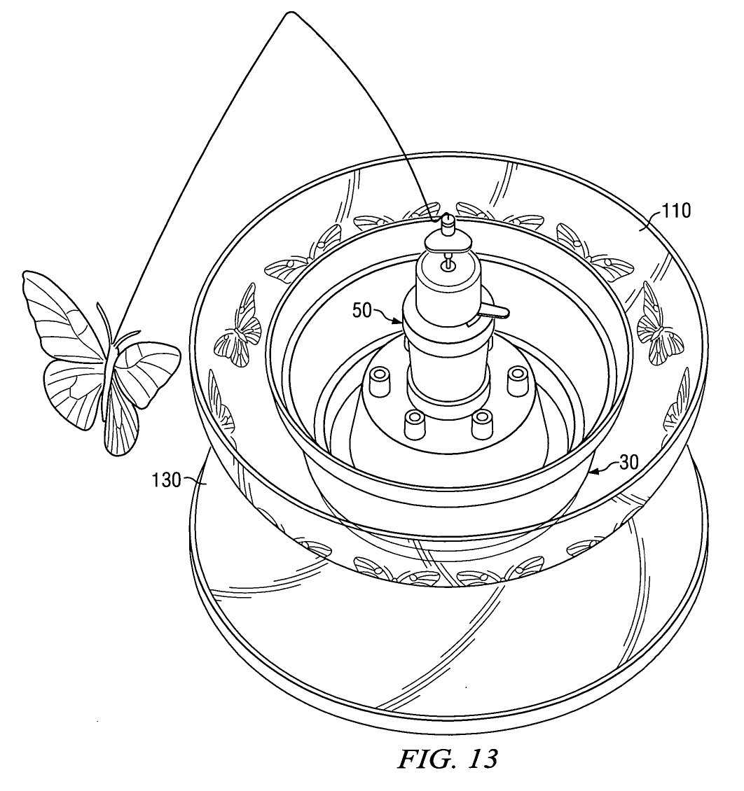

FIG. 7 shows a top perspective view of a configuration of a container 30. In this configuration, the container 30 includes a plurality of stem mountings 36, a motor assembly mounting 52, an opening 37 and a multi-tiered container body 39. The motor assembly mounting 52 is generally operable to support the motor assembly 50 (seen in FIGS. 8 and 9), the plurality of stem mountings 36 are generally operable to support or hold a stem of a flower (e.g., a rose or the like—not shown), the multi-tiered container body 39 is generally operable to support display item(s) 70 (seen, e.g., in FIG. 4) on different tier levels as should become apparent to one of ordinary skill in the art, and the opening 37 is generally operable to allow positioning of a variety of items therethrough. While a specific configuration of the container 30 has been shown in FIG. 7, it should be expressly understood that a variety of other configurations can be utilized as will become apparent to one of ordinary skill in the art. A similar container 30 is shown in a perspective view in FIG. 13 and will be described below.

FIGS. 8 and 9 are illustrative of a motor assembly 50 that can be utilized, according to several configurations of the invention. The motor assembly 50 of FIGS. 8 and 9 generally includes a body 56, a spinner 59, and a power switch 57. The body 56 generally includes the power supply and motor (not shown), which upon activation of the power switch 57 allow the spinner 59 to rotate. A wire 55 (connected to the object 20—e.g., a butterfly 25) can be inserted into the spinner 59, allowing the wire 55 and object 20 to be spun around. The general concept is described in U.S. Pat. No. 5,146,702. While this specific configuration of a motor assembly 50 has been provided, other configurations of a motor assembly 50 can be utilized—including not only those that are now known, but also those that will be later developed. In such configurations, it will be recognized that the motor assembly can be placed in other locations—e.g., towards the side of the display assembly 200 as opposed to being centrally positioned in the display assembly 200.

FIG. 10 is a perspective view, illustrating further details of configurations of the first member 110 and the second member 130. The first member 110 and the second member 130 in this configuration generally have a bowl-like configuration; however, the first member 110 and the second member 130 can have other configurations as will become apparent to one of ordinary skill in the art. The first member 110 has an upper end 117 and a lower end 115. At the upper end 117 of the first member 110 is an edge 118. At the lower end 115 of the first member 110 is a base 114 and a lower base 112. The lower base 112 includes an opening 116 disposed therein.

The second member 130 has a lower end 137 and an upper end 135. The lower end 137 generally includes a lip 132, which is arranged and designed to fit over the edge 118 of the upper end 117 of the first member 110—e.g., to arrive at a configuration similar to that of FIG. 1. The upper end 135 includes a first portion 134 and a second portion 138. The second portion 138 of the upper end 135 in this configuration is complimentary to the lower base 112 on the lower end 115 of the first member 110 and includes an opening 136. Additionally, the first portion 134 of the upper end 135 of the second member 130 in this configuration is arranged and designed to mate with the base 114 of the lower end 115 of the first member 110. The mating of the lower end 115 of the first member 110 to the upper end 135 of the second member 130 can produce a configuration similar to FIG. 11, described in more detail below.

FIG. 11 is generally illustrative of a display assembly 200 transitioned to a globe assembly display position. In this configuration, the lower end 115 of the first member 110 is mated with the upper end 135 of the second member 130. The first member 110 generally defines a container area 111, which can support or hold display item(s) 70—e.g., absent the container 30. The opening 116 (seen in FIG. 10) in the lower base 112 (seen in FIG. 10) of the lower end 115 of the first member can support and hold a motor assembly 50 (seen in FIGS. 8 and 9). The motor assembly 50 may also transverse at least partially into the opening 136 (seen in FIG. 10), depending on the size of the motor assembly 50. With this configuration, it can be seen that, according to certain aspects of the display assembly, the container 30 may not be utilized.

FIG. 12 shows a perspective view of the positioning of the motor assembly 50 within the container 30. The motor assembly 50 is generally shown disposed within a motor mounting 32. FIG. 12 also shows a multi-tiered container body 39, which helps define a container space 34, and a plurality of stem mountings 36. The motor mounting 32 and the plurality of stem mountings 36 are elevated upon a member 33. One of the lower tiers in the container body 39 forms a lower end 31 of the container 30. As referenced above, the spinner 59 can rotate the wire 55, which rotates the object.

FIGS. 13 and 14 show the mounting of the container 30 within the first member 110. A lower end 31 of the container 30 is complimentary to an internal portion of the lower base 112 of the first member 110. FIG. 14 shows the second member 130 removed to further illustrate the positioning of the lower end 31 of the container 30 in an internal portion of the lower base 112 of the first member 110. In this particular configuration, if one were to remove the motor assembly 50 of FIG. 13, an opening 37 in communication with an opening 116, which is in communication with an opening 136 (seen in FIG. 10) could be seen. Accordingly, a motor assembly 50 with a larger base portion could be inserted through such openings 37, 116, and 136.

FIG. 15 is generally illustrative of a display assembly 200 transitioned to a marketing display position. In this position, two or more display assemblies 200 are stacked—one on top of the other. For example and with reference to FIGS. 10 & 15, the lower base 112 of the lower end 115 of the first member 110 of the upper display assembly 200 is positioned in the second portion 138 of the upper end 135 of the second member 130 of the lower display assembly 200. Utilizing such a technique, a plurality of display assemblies 200 can be stacked. Once again, in a preferred embodiment, the globe assembly 100 is made of clear plastic. As such, a clear view is provided of the contents of each respective display assembly 200. For example, a consumer can see what type of display item(s) 70 is within the globe assembly 100—thereby allowing a selection of a particular type of display item(s) 70. Additionally, the top display assembly 200 can be transitioned into a display position to accentuate the entire stack of display assemblies 200.

Thus, it can be seen that the display assembly 200 can be utilized in a variety of configurations for a variety of occasions. As an example, intended for illustrative purposes only, the display assembly 200 can be delivered to individuals in a manner similar to delivery of candy grams or floral displays as a gift. Then, the display position can be revealed to draw attention to the recipient by accentuating the display assembly 200 and/or the display item(s) 70 therein.

As another example, also intended for illustrative purposes only, the display assembly 200 can be mailed to a recipient as a gift. In such a mailing, the globe assembly 100 in a packaged position (FIG. 1) helps to protect the display item(s) 70 and/or container 30 during shipment. When the shipment arrives, the display assembly 200 can be transformed into the other positions (e.g., the display position of FIG. 4)—serving a second function in the transformed position.

In yet a further example, also intended for illustrative purposes only, the display assembly 200 can serve as a central piece at a party or event, accentuating the particular location of the display assembly 200 and/or the display item(s) 70 therein.

With the above examples, it can be seen that the globe assembly 100 can provide a plurality of functions. For example, in the packaged position configuration of FIG. 1 or the protected display position of FIG. 5, the globe assembly 100 serves to protect the display item(s) 70—the display item(s) 70, being cookies, candy, flowers, or the like. In the display position of FIG. 4, the globe assembly 100 serves to display another object—namely the container 30 with display item(s) 70 therein and an object 20 flying therearound. In the container position of FIG. 11, the globe assembly 100 serves to hold the display item(s) 70, itself. In the marketing display position of FIG. 15, the globe assembly 100 serves to facilitate a stackability of the display assemblies 200.

Thus, it is apparent that there has been provided, in accordance with the present invention, a display assembly and method that satisfies one or more of the advantages set forth above. Although the preferred embodiment has been described in detail, it should be understood that various changes, substitutions, and alterations can be made herein without departing from the scope of the present invention, even if all of the advantages and benefits identified above are not present. For example, the various elements or components may be combined or integrated in another system or certain features may not be implemented. Also, the techniques, systems, sub-systems, and methods described and illustrated in the preferred embodiment as discrete or separate may be combined or integrated with other systems, techniques, or methods without departing from the scope of the present invention. For example, a variety of different objects 20 and item(s) 70 can be utilized with the display assembly 200. Other examples of changes, substitutions, and alterations are readily ascertainable by one skilled in the art and could be made without departing from the spirit and scope of the present invention.

What is claimed is:

1. A display assembly, operable for storing and displaying an item, comprising:
a first member,
a second member, operable for positioning with the first member, wherein
an upper end of the first member is positionable with a lower end of the second member in a first position,
an upper end of the second member is positionable with a lower end of the first member in a second position,
the first member and the second member in the first position store the item, and
the first member and the second member in the second position display the item.

2. The display assembly of claim 1, wherein the upper end of the second member and the lower end of the first member is further configured for a stacking of a plurality of display assemblies.

3. The display assembly of claim 1, further comprising:
a container, removably positionable with the first member, wherein the container is operable to support the item.

4. The display assembly of claim 1, further comprising:
an object coupled to the first member and suspended to accentuate the display assembly.

5. The display assembly of claim 4, wherein the object is coupled to a central portion of the first member.

6. The display assembly of claim 4, further comprising:
a wire coupled to the first member, wherein the object is suspended from the wire.

7. The display assembly of claim 6, further comprising:
an opening in the second member, wherein the wire is positionable through the opening such that the object is capable of being suspended outside of the second member when the display assembly is in the first position.

8. The display assembly on claim 4, wherein the object is movable.

9. The display assembly of claim 8, further comprising:
a motor assembly, operable to move the object, wherein the object is coupled to the motor assembly and the motor assembly is coupled to the first member.

10. The display assembly of claim 9, further comprising:
a container, coupled to the first member, wherein
the container is operable to support the item, and
the motor assembly is coupled to the to the container.

11. The display assembly on claim 9, further comprising:
a wire coupled to the motor assembly, wherein the object is suspended from the wire.

12. The display assembly on claim 11, wherein the motor assembly includes:
a spinner, operable for rotating the object around the display assembly.

13. The display assembly on claim 4, wherein the object is a butterfly and the item is a floral material.

14. The display assembly on claim 1, wherein at least one of the first member and the second member has a bowl-like configuration.

15. The display assembly on claim 1, wherein the first member and the second member have bowl-like configurations.

16. The display assembly on claim 1, wherein
the lower end of the first member includes a base and a lower base protruding out from the base,
the upper end of the second member includes a first portion and a second portion recessed from the from the first portion, and
the lower base of the lower end of the first member is positionable within the second portion of the upper end of the second member.

17. The display assembly on claim 16, wherein
the base of the lower end of the first member mates with the first position of the upper end of the second member when the lower base of the lower end of the first member is positioned within the second portion of the upper end of the second member.

18. The display assembly on claim 16, further comprising:
a container, having a lower end removably positionable with an internal portion of the lower base of the lower end of the first member, wherein the container is operable to support the item.

19. The display assembly of claim 1, further comprising:
a container, operable to support the item;
a motor assembly, coupled to container;
a wire, coupled to the motor assembly; and
an object, suspended from the wire, wherein
the motor assembly is operable to move the object around the display assembly,
the lower end of the first member includes a base and a lower base protruding out from the base,
the upper end of the second member includes a first portion and a second portion recessed from the from the first portion,
the lower base of the lower end of the first member is positionable within the second portion of the upper end of the second member, and
a lower end of the container is removably positionable with an internal portion of the lower base of the lower end of the first member.

20. A method of storing and displaying an item, the method comprising:
providing a display assembly with a first member and second member, the second member operable for positioning with the first member;
storing the item in a first position of the display assembly by positioning an upper end of the first member with a lower end of the second member;
transitioning the display assembly to a second position by positioning an upper end of the second member with a lower end of the first member; and
displaying the item with the display assembly in the second position.

21. The method of claim 20, further comprising:
removably positioning a container with the first member, wherein the container is operable to support the item.

22. The method of claim 20, further comprising:
suspending an object above the second member to accentuate the display assembly.

23. The method of claim 23, further comprising:
moving the object about the display assembly.

24. An apparatus, operable for displaying and accentuating an item, the apparatus comprising:
a container, comprising:
a container body, operable for storing the item, wherein the container body defines a container space that extends from a lower end of the body,
an object,
a motor assembly, positioned with the container comprising:
a spinner, and
a wire, wherein
the object is suspended from the wire, and
the spinner spins the wire and object around the container to accentuate the item within the container body.

25. The apparatus of claim 24, wherein the object is a butterfly and the item is a floral material.

26. The apparatus of claim 24, wherein the container further comprises:
stem mountings, operable to support the item.
